(19) United States
(12) Patent Application Publication
(10) Pub. No.: US 2005/0240518 A1
(43) Pub. Date: Oct. 27, 2005

(54) Method and system for on-line communication based on an off-line transaction

(75) Inventor: Hiroaki Ishizuka, San Jose, CA (US)

Correspondence Address: OBLON, SPIVAK, MCCLELLAND, MAIER & NEUSTADT, P.C., 1940 DUKE STREET, ALEXANDRIA, VA, 22314, US

(73) Assignee: RICOH COMPANY LTD.

(21) Appl. No.: 09/725,511

(22) Filed: Nov. 30, 2000

(51) Int. Cl. G06F 17/60

(52) U.S. Cl. 705/39; 705/40

(57) ABSTRACT

A method and system for communicating the approval of a purchase, and also billing for the purchase. Information related to the financial situation of a customer which was obtained from an off-line transaction is stored. Subsequently, a customer desires to enter into an on-line purchase. The previous information obtained from the off-line transaction is utilized to approve of a credit purchase by the customer. In response to such approval, the order may be shipped and subsequently, or simultaneously, an electronic or other bill or receipt is sent.

### BACKGROUND OF THE INVENTION

1. Field of the Invention

The present invention relates to the use of information obtained from an off-line transaction for communication related to an on-line transaction. The invention is more particularly related to the use of an analysis of characteristics of a purchaser when considering whether or not to grant authorization for a transaction.

2. Discussion of the Background

Transmitting a bill or invoice for services or products by an electronic means such as over a computer network is conventional. For example, the company CheckFree i-Solutions offers an electronic billing and payment product called i-Biller, which includes features applicable to the present invention and is incorporated herein by reference. For example, a utility such as a phone company may send by e-mail a bill such as that illustrated in FIG. 10. As an alternative to receiving this bill by e-mail, the bill may be downloaded at the user's request in any desired format, such as the Adobe Acrobat PDF format, or in a spreadsheet format. The user is also able to pay the bill on-line, for example, using the form or screen display illustrated in FIG. 11. Information regarding the CheckFree i-Biller software is currently available from the Internet site HTTP://www.bluegill.com.

A drawback of conventional electronic bills which I have discovered is that a person must enter their billing and personal information at least once. Thus, even in a system such as Amazon.com's one-click system, see U.S. Pat. No. 5,960,411 which is incorporated herein by reference, the user must enter his or her billing information. I have determined that it would be preferable if the user did not have to go through the tedious task of himself or herself entering all of his billing information.

### SUMMARY OF THE INVENTION

It is therefore an object of the present invention to overcome deficiencies of known billing systems. It is a further object of the invention to provide a billing system in which at least some information of or about the user which is obtained from an off-line transaction is utilized for an on-line transaction. As an alternative or in addition to the above objects, it is a further object of the invention to have a billing system which transmits a bill electronically to a customer.

In accordance with the invention, financial information of a customer is obtained based on an off-line transaction. For example, the off-line transaction may be the lease or sale of an image forming device such as a copier, facsimile machine, printer, multifunction machine, or other device. A multifunction machine includes copying, and/or printing, and/or facsimile, and/or scanning functions. Based on the off-line transaction, a determination can be made as to whether credit should be extended to the customer for subsequent purchases. The subsequent purchases are preferably on-line purchases and even more preferably are for supplies for the image forming apparatus which is the basis for the off-line transaction. For example, if the off-line transaction relates to a lease of a copier, credit may be extended for an on-line purchase of toner for that copier, based on the off-line transaction and/or an appropriate credit check, if desired. The above non-limiting example has been presented to provide a quick overview of the invention, although this example is not the only method of operating the invention and alternatives are possible. For example, the customer's financial information may be obtained in any desired manner, the information related to the availability of the issuance of a bill may be transmitted to the customer in any desired manner, and the bill issued to the customer may be in electronic or paper format.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1 illustrates a computer system for use with the invention;

FIG. 2 illustrates the customer computer of FIG. 1;

FIG. 3 illustrates the supplier computer system of FIG. 1;

FIG. 4 illustrates a sample lease for an imaging device;

FIG. 5 is a flowchart for customer registration used by the present invention;

FIG. 6A-6D are a flowchart showing the purchase and billing process of the invention;

FIG. 7 is a screen display which may be shown when a customer purchases supplies for an image forming device which has been leased or purchased;

FIG. 8 is a screen display showing three alternative manners of selecting for purchase the supplies which are desired;

FIG. 9 is a screen display shown to a user towards the end of a transaction;

FIG. 10 shows an example electronic bill of a conventional system; and

FIG. 11 shows the ability to pay on-line an electronic bill of a conventional system.

### DESCRIPTION OF THE PREFERRED EMBODIMENTS

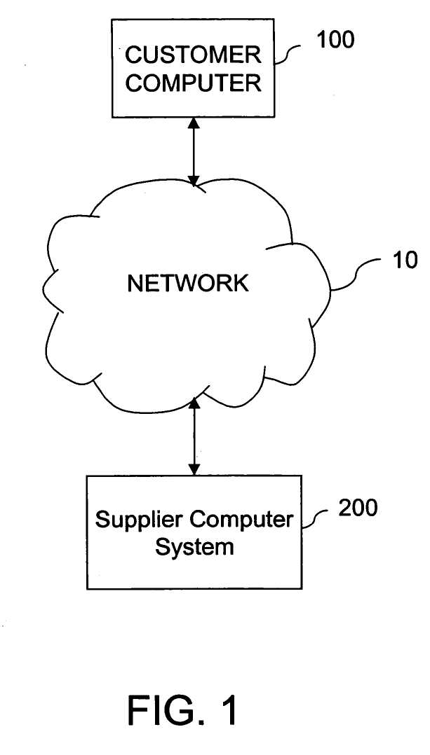

Referring now to the drawings, wherein like reference numerals designate identical or corresponding parts throughout the several views, and more particularly to FIG. 1 thereof, there is illustrated a computer system according to the present invention. In FIG. 1, there is a customer computer or computer system 100 connected to a network 10. The network 10 preferably includes the Internet, although the invention is not limited to using only the Internet and includes the use of other types of networks such as but not limited to a Wide Area Network (“WAN”), a private network, or a Virtual Private Network, for example. Also connected to the network 10 is a supplier computer system 200. In FIG. 1, the customer computer 100 is a computer used by an entity including a person, company, corporation, or any other entity which desires to obtain or purchase some type of goods or services. The supplier computer system 200 is a computer system used for selling, auctioning, volume buying, buying in which a price is set based on the number of items being purchased, or transferring or providing goods or services using any other type of sales model. The supplier computer system 200 may be owned by the actual supplier, may be owned by an independent third party which is associated with the supplier and provides computer services or sales services for the supplier, and/or owned or operated by any desired entity including but not limited to an independent third party.

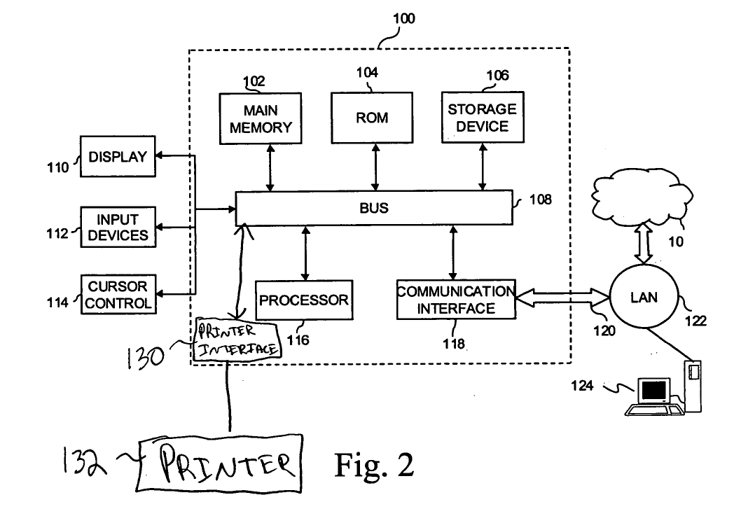

The customer computer 100 is illustrated in more detail in FIG. 2. The customer computer 100 may be implemented as a general purpose computing system which has access to a network such as the Internet, although any type of computing device may be utilized as the customer computer 100 including, but not limited to, desktop devices, portable computing devices, palm-type computing devices, a cellular phone having web browsing capabilities connected to the Internet, a device having a wired or wireless connection to the Internet, or any other desired computing device. For the exemplary computer 100 illustrated in FIG. 2, there is a main memory 102, such as a random access memory (“RAM”) or other storage device, e.g., dynamic RAM (“DRAM”), static RAM (“SRAM”), synchronous DRAM (“SDRAM”), and/or flash RAM, which stores information and/or instructions to be executed by a processor 116. The processor 116 may be any desired type of processing circuitry including, but not limited to a specialized processing device or, a microprocessor such as a microprocessor from Intel, AMD, Texas Instruments, Hitachi, or any other processor manufacturer. In addition, the main memory 102 may be used for temporarily storing temporary variables or other intermediate information used or generated during the execution of instructions by the processor 116. Customer computer 100 also includes a read only memory (“ROM”) 104 or other static storage device such as a programmable ROM (“PROM”), an erasable PROM (“EPROM”), and/or an electrostatically erasable PROM (“EEPROM”) for storing static information and/or instructions for processor 116. A storage device 106 such as magnetic disk, optical disk, magneto-optical disk, semiconductor memory, or any other type of storage device is utilized for storing information and/or instructions.

The customer computer 100 may also include special purpose logic devices (e.g., application specific integrated circuits (“ASICs”)) or configurable logic devices (e.g., generic array or logic (“GAL”) or reprogrammable field programmable gate arrays (“FPGAs”)). Other removable media devices (e.g., a compact disc, a tape, and/or a removable magneto-optical media, or other type of optical media) or fixed, high-density media drives may be included in the computer 100 by connection to an appropriate device bus (e.g., a small computer system interface (“SCSI”) bus, an enhanced integrated device electronics (“EIDE”) bus, or an ultra-direct memory access bus). The computer 100 may also include a compact disc reader, a compact disc reader-writer unit, or a compact disc jukebox, each of which may be connected to a device bus or any type of bus such as a bus 108 in FIG. 2 which connects the various components of the computer 100.

The computer system 100 may be coupled via the bus 108 to a display 110 such as a cathode ray tube or liquid crystal display for displaying information to a user of the computer 100. The display 110 may be controlled by a display or graphics card. Further, the computer system includes input devices 112 such as a keyboard or other input device, and a cursor control 114 for communicating information and command selections to the computer 100. The cursor control 114, for example, may be implemented as a mouse, a track ball, cursor direction keys, or any other desired pointing device for communicating direction, location, or selection information, and/or command selections to processor 116 and for controlling cursor movement on the display 110. Further included in FIG. 2 is a printer interface 130, connected to the bus 108, which allows the outputting of desired information on a printer 132. The printer 132 may be implemented as any desired type of printing device including, but not limited to, a laser beam based printing device, an ink jet printing device, an LED based printing device, an impact printer, or any other desired type of printer. The printer 132 may be utilized to print bills generated by the present invention or to print any other desired type of information.

The customer computer 100 communicates with the supplier computer system 200. One manner of communicating by the customer computer is over a local area network (“LAN”) such as the LAN 122 illustrated in FIG. 2. For a typical business customer, access to the network 10 and/or the Internet in order to gain access to the supplier computer system 200 is through a LAN and in such a situation, a communication interface 118 may be implemented as a network interface card which communicates with the LAN 122 over a connection 120. The LAN 122 may have access to the network 10 via a router, server, or any other desired computing or routing device. A generic computer 124 is also shown to be connected to the LAN 122 in order to demonstrate that it is possible, although not necessary, for the LAN to be connected to a number of computers. It is also possible for the communication interface 118 to be implemented as any other desired communication interface, such as a wireless interface, or through a modem wired to a public switched telephone network (“PSTN”). In this case, the LAN 122 may not be necessary, although it may be utilized for another purpose. Moreover, the modem may be an individual modem or a modem pool which is available to a number of computers on the LAN 122. In this case, the interface between the LAN 122 and the network 10 would be through a modem and PSTN or IDSN. The communication interface 118 may be alternatively implemented as an asymmetrical digital subscriber line (“ADSL”) card, an integrated services digital network (“ISDN”) card, or a modem to provide a data communication connected to a corresponding type of telephone line. Additionally or alternatively, wireless links may be implemented using electrical, electromagnetic, optical, or audio signals that carry data streams representing various types of information.

As stated above, the computer 100 preferably includes at least one computer readable medium or memory programmed for storing the program code utilized to carry out or for performing all or a portion (if processing is distributed) of the processing performed when implementing the present invention. Computer code devices of the present invention may be any interpreted or executable code mechanism, including but not limited to scripts, interpreters, dynamic link libraries, Java classes, and complete executable programs. Moreover, parts of the processing of the present invention may be distributed for better performance, reliability, and/or cost.

The term “computer readable medium” as used herein refers to any medium that participates in providing instructions to processor 116 for execution. A computer readable medium may take many forms including but not limited to, non-volatile media, volatile media, and transmission media. Non-volatile media includes, for example, optical, magnetic disks, and magneto-optical disks, such as the storage device 106, and volatile media includes dynamic memory, such as the main memory 102. Transmission media includes coaxial cables, copper wires, fiber optics, wires that comprise the bus 108, and also the atmospheric or local environment through which acoustic, light, or radio frequency waves are transmitted for communications.

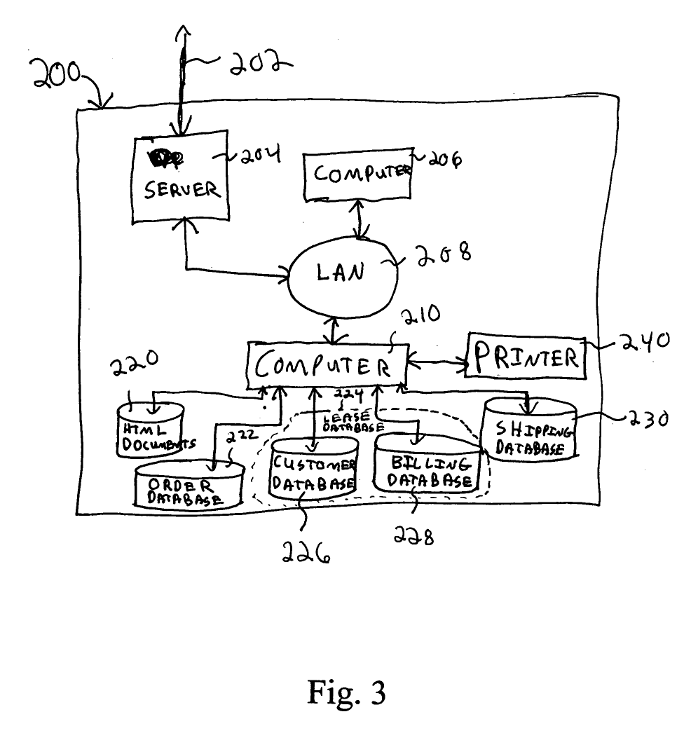

FIG. 3 is an illustration of the supplier computer system 200. It is emphasized that the supplier computer system 200 is one exemplary implementation and any desired structure or arrangement of the computer system may be used to carry out the present invention. In FIG. 3, the supplier computer system 200 includes a server 204 which is connected to the network 10 via a connection 202. This connection 202 may be made in any desired manner including utilizing a T1 line, utilizing a DSL or ADSL connection, utilizing a modem, phone lines, copper wires, a wireless connection or in any other desired manner of connecting to the network 10. The server 204 functions to provide an interface to the network 10 and may be implemented as an Internet or web server, if desired. Alternatively, a computer 210 may be utilized as the web server or as a server which provides the desired information to or over the network 10. Each of the servers or computers 204, 206, and 210 illustrated in FIG. 3 may have any desired structure and may be implemented using a server or other computer such as the computer described and illustrated with respect to FIG. 2.

The computer 210 has access to various databases and storage devices including a storage device 220 which stores Hyper Text Markup Language (“HTML”) documents 220. These HTML documents may be utilized to present any desired information to the customer computer 100 including, but not limited to, information related to billing, computer status, supplies available for purchase, advertisements, or any other desired type of documents or information. Moreover, HTML is one manner of storing these documents and other implementations are possible including Extensible Markup Language (“XML”) documents, PDF documents, and/or any desired format documents. An order database 222 stores information related to orders placed by customers for goods or services which are desired. Preferred orders include supplies for image forming devices such as components and supplies for copiers, printers, and facsimile machines including, but not limited to, toner, developer, staples, fuser, rollers, paper, and/or any other desirable supplies, components, or items.

In a preferred embodiment of the invention, information related to a customer or consumer is stored in a lease database 224, which may be implemented using any desired database format and structure. In an exemplary embodiment, a customer database 226 stores information regarding the customer including contact information such as the name, address, city, telephone number, and if desired, information about what was leased (or purchased) off-line. The lease database 224 is not necessary or essential to the present invention, especially when the off-line transaction does not involve a lease. However, it may be desirable to store information corresponding to the off-line transaction in some type of database. A billing database 228 keeps track of the billing information of the customer including, but not limited to whether the customer is behind on payments or current on payments, the amount of money the customer owes, how many payments are left, the value of the equipment, and/or any other desired billing information. A shipping database 230 contains information related to orders which have been shipped or need to be shipped. These orders are preferably for supplies for image forming devices, but may be orders for any other type of shipment including, but not limited to any electronic commerce shipment or sales such as for books, toys, travel tickets, or other items which are desired to be purchased. A printer 240 is connected to the computer 210. The various computers 210, 206, and 204 may be connected by a LAN 208. The various databases and/or storage devices in FIG. 3 are illustrated as being separate storage devices, although they may be implemented within one storage device including multiple databases, multiple storage devices for one database, multiple storage devices for multiple databases, or in any other desired manner.

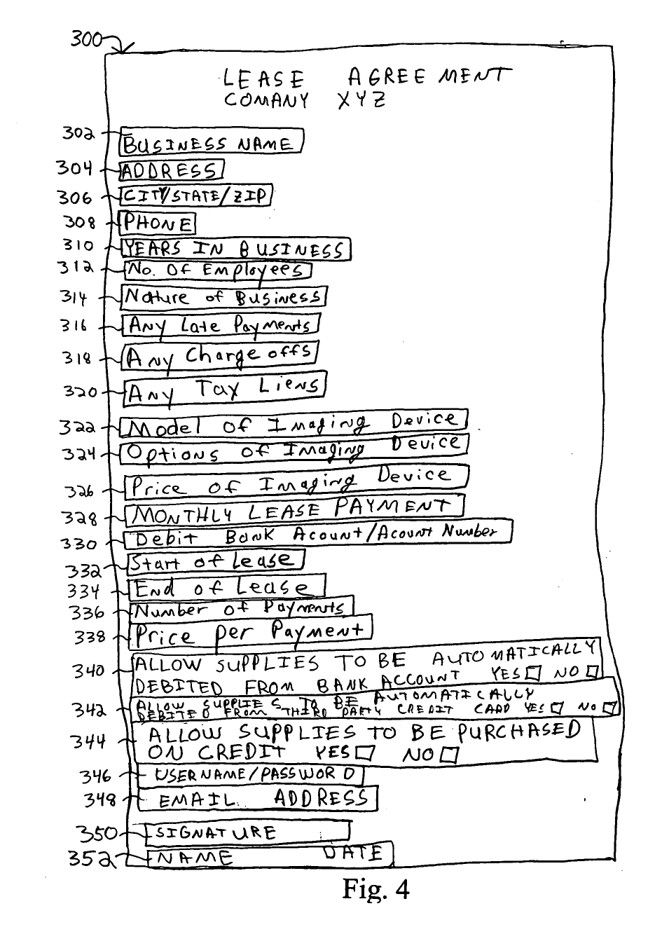

One feature of the present invention is utilizing information obtained from or based on an off-line transaction in order to determine whether subsequent on-line transaction(s) should proceed or be authorized. Any desired off-line transaction may be utilized but a preferred embodiment of the invention utilizes information obtained from a purchase or lease. This purchase or lease is preferably of an image forming device, also referred to as an imaging device. According to an embodiment of the invention, a lease agreement for an image forming device such as a copier, facsimile machine, or printer is utilized to obtain financial or other information from a customer. In the lease agreement 300 illustrated in FIG. 4, it is seen that the lease is from company XYZ which is the provider or lessor of the image forming device. This lease may be with the manufacturer, a distributor, retailer, or other provider or agent related to the transaction of providing the imaging device, or other goods or services.

In FIG. 4, exemplary fields of a lease are illustrated. The invention is not limited to the use of these fields, but any desired fields in a lease may be utilized. The lease contains the field Business Name 302 which is the name of the company which will utilize the leased device under the terms of the lease and is usually the lessee. Address field 304 is the address of the company, and field 306 contains the city, state, and zip code of the lease. Other fields may be utilized to identify the location of the business, depending upon the organization and country utilized. Phone field 308 is the business phone number of the company.

Field 310 contains the Years In Business, field 312 contains the Number of Employees, and field 314 contains the Nature of the Business. The fields 310, 312, and 314 may be utilized to make a decision as to whether the company at issue which desires the equipment by way of a lease is a suitable risk for extending the lease. If the company has been in business for 50 years and has 500 employees, the company will, according to statistics, probably not go bankrupt in the near future, unless the company is in an area of business which is having a particularly difficult time. Fields 316, 318, and 320 which respectively relate to late payments of the company, charge-offs of the company which are old bills which the company never paid and were forgiven by the party extending credit, and whether there are any tax liens which indicate information about the past actions of the company which desires to lease the equipment may be a good indicator of the future ability to make payments. While fields 310-320 can be utilized to determine whether it is appropriate to extend credit to the lessee either for the lease of the imaging device, or for subsequent supplies desired for the imaging device, it is not necessary to use each of these fields, and additionally alternative fields or factors can be utilized to determine the credit worthiness of the customer. For example, the gross revenue of a company may be utilized, the value of the company may be utilized, the number of active customers of the company may be utilized, or any other factor which may be utilized to determine the credit worthiness or the reliability of the customer may be utilized, as desired. Formulas for establishing credit worthiness of a company and/or individual are generally known.

Other items which may appear on the lease agreement include the Model of the Imaging Device 322, and the Options of the Imaging Device 324. The Options of the Imaging Device 324 may be utilized in order to display supplies which may be particularly applicable for utilization in the imaging device being leased or purchased. For example, if the copier which is being leased (or purchased) has a stapler as part of the finishing options of the copying process, the storage of this information may allow an indication to be presented to the user of the particular type of staple which is to be used within the copier. As a further example, a facsimile machine or printer may have a color option installed and the user may be provided with an indication of the type of color ink cartridges or toner which is usable with the imaging device.

Other types of information which may appear on the lease agreement 300 include the Price of the Imaging Device 326, the amount of the Monthly Lease Payment 328, an indication as to whether there should be an automatic debiting of a bank account and/or the account number from which the lease payments (or monthly payments for a purchase) are to be made. A date indicating a Start of the Lease 332, a date indicating an End of the Lease 334, a Number of Payments to be made on the lease 336, and a Price per Payment 338.

An optional feature of the invention is an indication as to how credit may be extended or money utilized to allow the future purchase of supplies for the imaging device. A field 340 allows the user to have the price of purchased supplies be automatically debited from a bank account. A field 342 allows supplies to be automatically debited from a third party credit card such as Visa, Master Card, American Express, or any other third party credit card. Moreover, as an alternative, if the user falls behind on payments to the supplier or lessor, there may be a provision or agreement that a third party credit card can be automatically billed as a back-up manner of attempting to collect on good or services which have been provided. Field 344 indicates whether it is permitted for supplies to be purchased on credit. For example, if a person in charge of leasing or purchasing imaging supplies is concerned with theft within the company, or does not desire to buy supplies from the company supplying the equipment, the box NO can be checked indicating that no supplies are to be purchased on credit. If the purchaser or lessee of the equipment desires to purchase supplies, then the box YES can be checked.

Regarding electronic contact between the lessor and lessee (or purchaser and seller), a preferred form of communication is over the Internet. The communication may be made by electronic mail or via the World Wide Web using a URL or IP address, for example. The purchaser or lessee who is to obtain the equipment can select or indicate a desired user name and/or password for electronic communications in field 346 of the example lease agreement. Also, if desired, an e-mail address may be entered in field 348 to which electronic bills and other information may be sent. Further, the lease agreement contains a signature block and a field 352 which contains the name of the signing party and the date on which the document was signed.

While FIG. 4 illustrates a lease, any type of agreement document, or information can be utilized to obtain information from an entity which will purchase, obtain, or utilize subsequent supplies, components, items, or services at a future data. For example, a purchase agreement may be utilized instead of a lease agreement. Moreover, while the preferred embodiment utilizes supplies for an imaging device which is purchased or leased, and the supplies are directly related to the off-line transaction through which the device which uses the supplies were obtained, the subsequent purchase of items or services does not have to be of items or services related to the off-line transaction, but may be completely unrelated to the initial item through which the credit information was obtained.

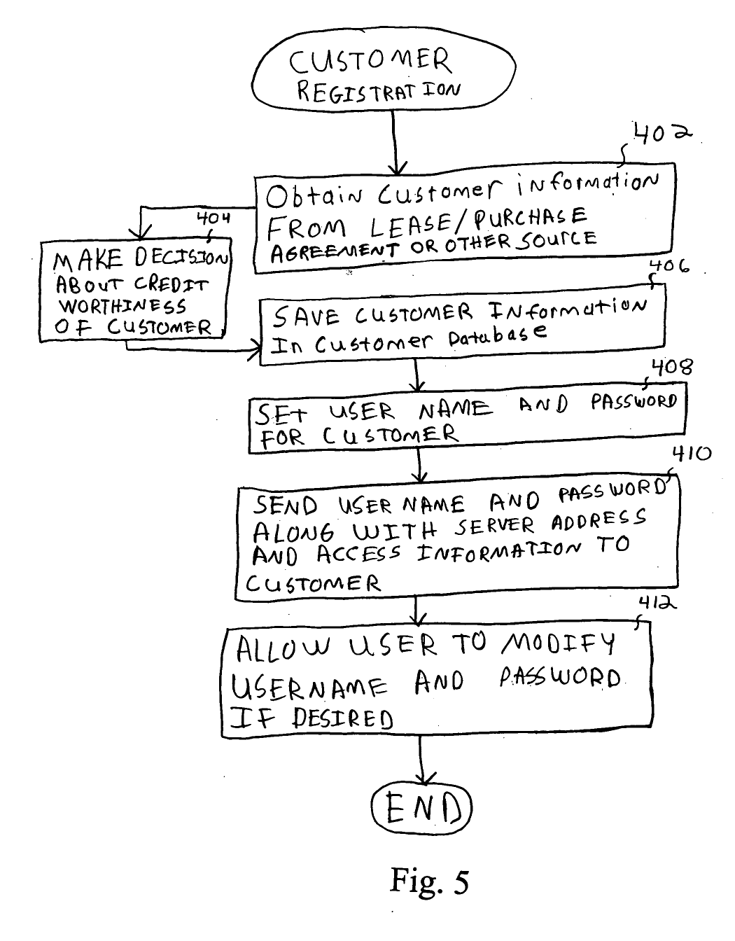

It is preferable to register a prospective customer (or actual customer) who will purchase desired goods or services, preferably though an on-line transaction. FIG. 5 illustrates an embodiment of how information regarding the customer is obtained and whether or not credit is to be extended to the customer. After starting in FIG. 5, in step 402 customer information is obtained. A preferred source of this customer information is from a lease or purchase agreement, although any source of information may be utilized. For example, the information written on lease 300 may be utilized to obtain the desired customer information. This information may be obtained directly from the lease, may be obtained from a database already containing the desired information such as the database 224 illustrated in FIG. 3, or may be obtained from any other source. The customer information is preferably obtained from an off-line transaction, which means that the customer does not make the purchase or lease directly using the Internet or other form of e-commerce, but typically a sales representative will meet with the customer either at a location of the customer or at a location where the sales representative works (or at an intermediate location). Further, the off-line transaction information may ultimately be stored on-line, but it is preferable that the customer does not interact with a computer to enter this information.

After obtaining customer information in step 402, a decision may be made in step 404 about the credit worthiness of a customer, lessee or purchaser. This decision or evaluation can be as simple or as complicated as desired. For example, at the simple end of the spectrum, the mere fact that a customer has leased a copier which may be a relatively expensive piece of equipment or other device could be sufficient by itself to indicate that the customer is sufficiently credit worthy to extend credit for the purchase of supplies of the copier or other device. On the other hand, a more complicated decision making process or evaluation may be utilized to determine the credit worthiness of the customer. For example, any of the fields of the lease agreement illustrated in FIG. 4 may be utilized or evaluated. In a preferred embodiment of the invention, a simple determination such as whether or not the customer is current on his lease and/or purchase payments is usually sufficient to decide whether or not credit is to be extended to the customer for supplies. Customer information regarding the decision about the credit worthiness and/or other customer information from the lease is stored in a customer database such as the database 226 illustrated in FIG. 3. Alternatively and/or additionally, the customer information may be saved in a location other than a customer database. The saving of this customer information may be the initial saving of all of the information from the lease or purchase agreement, or the saving of information may be made at a later time after the lease transaction or purchase transaction has been completed.

In step 408, the user name and password for the customer is set. This information may be requested or provided at the time of the lease or purchase for example, in fields 346 of the lease 300 of FIG. 4, or alternately, the user name and password may be randomly, or pseudorandomly assigned. The user name and password may also be set to some default value such as the business name or name of the person entering into the lease or purchase, and the password could be some predetermined fields such as the phone number, company name, or any other desired value. If the user did not previously specify the desired user name and/or password, or even if the user did specify the desired user name and password, step 410 may be performed which sends the user name and password along with the server address and access information for the computer which is utilized for the purchase of supplies. The information recited in step 410 may be sent by electronic mail to the user. The electronic mail address of the user may be obtained from field 348 of the lease 300. The server address may be the IP (“Internet Protocol”) address or the corresponding URL, and if desired, the access information may be information which indicates how supplies may be purchased on the web site. After step 410, step 412 is performed which allows the user to modify the user name and corresponding password, if so desired by the user. The process of FIG. 5 may also be performed by a user going to the Internet address or web site of the company selling the desired goods or services, the product originally sold or leased, or the manufacturer of the product which was sold or leased and the user can indicate a desire to register. In order to obtain the desired information, the information can be obtained from a database which has already stored the information, or the request by the user may trigger a reevaluation or an entry or re-entry of the information from the original purchase or lease agreement. After step 412, the process of FIG. 5 ends.

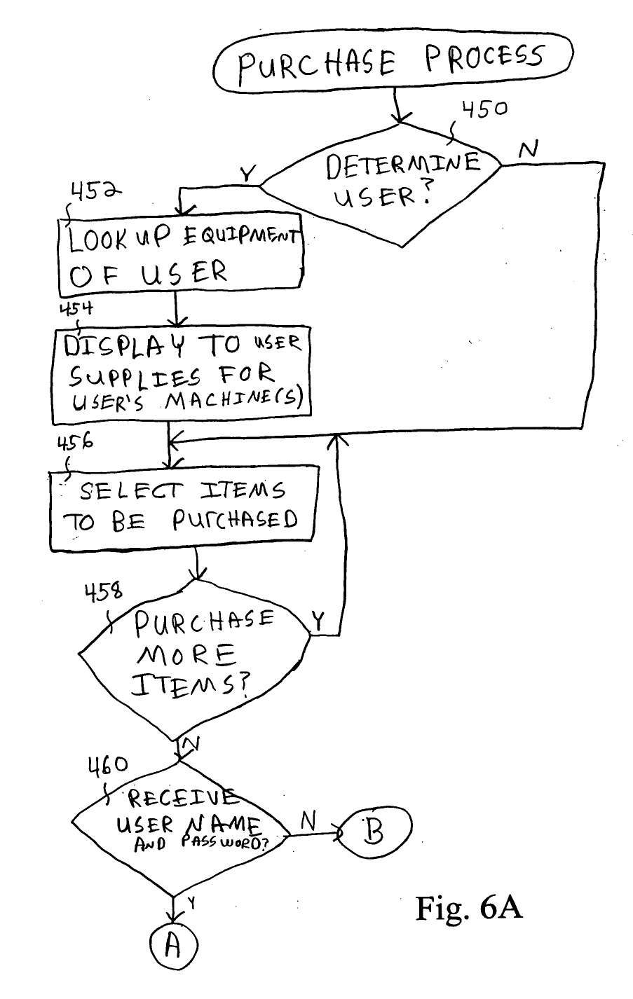

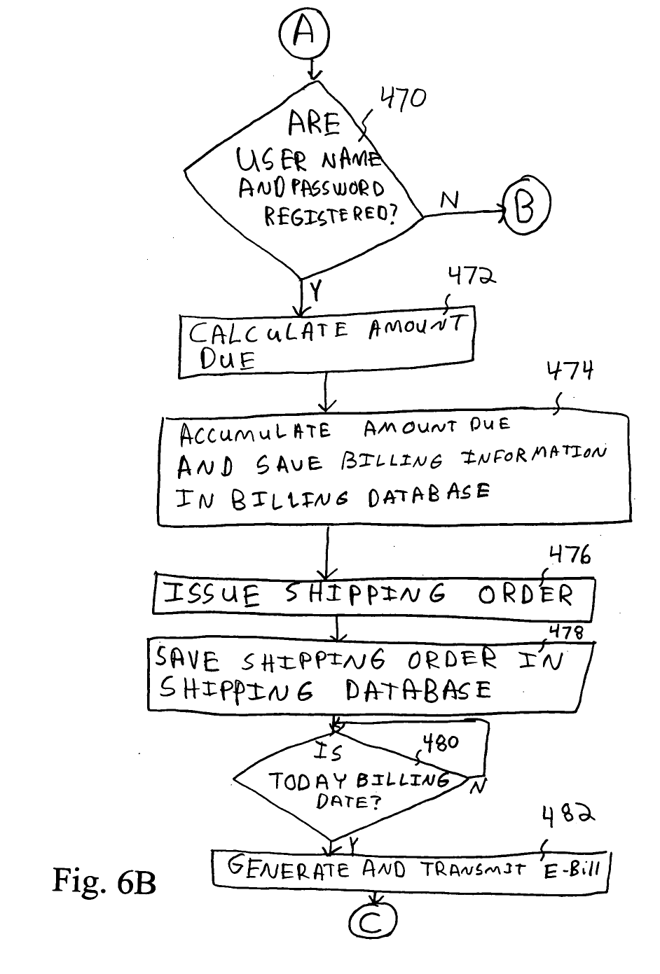

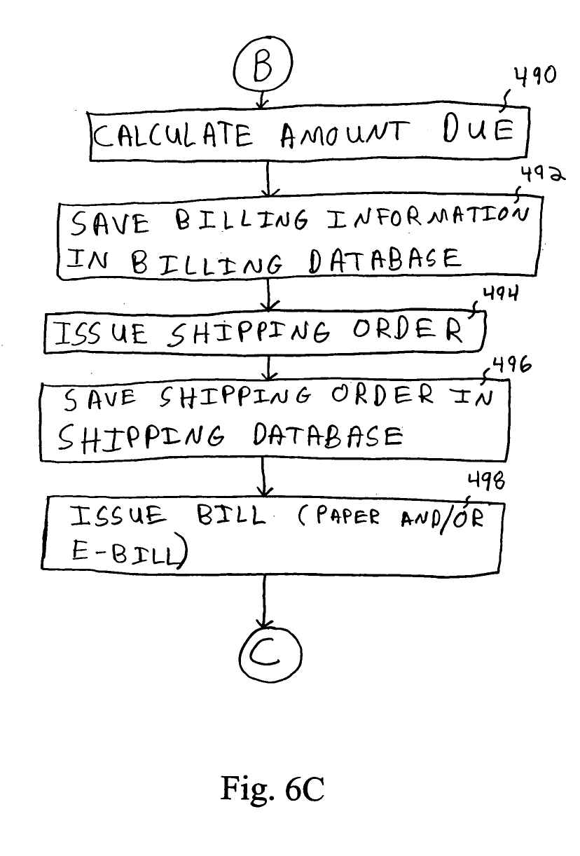

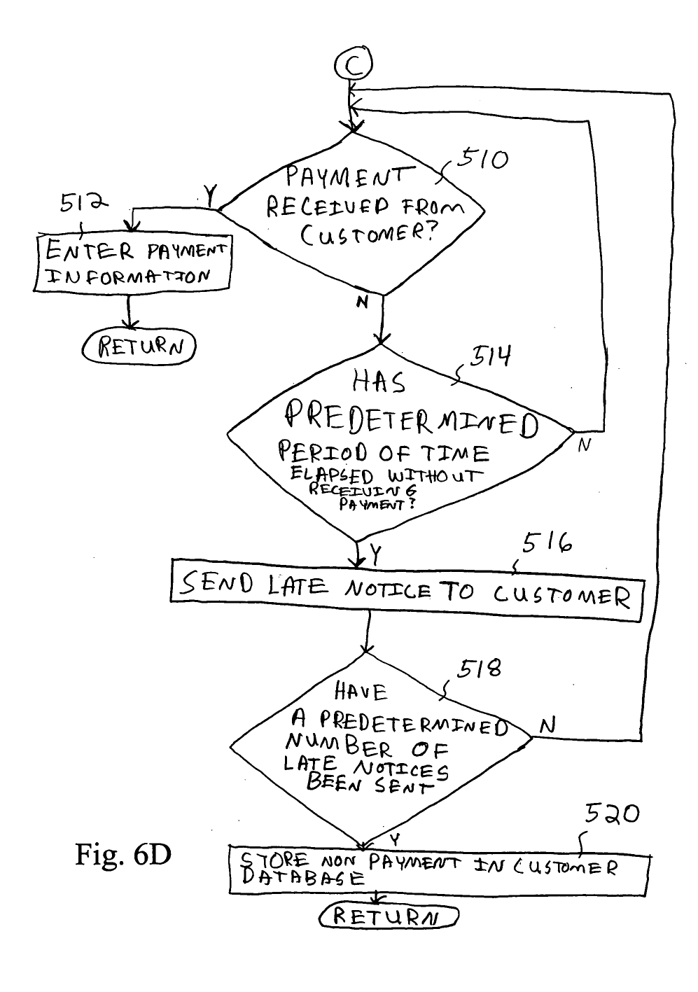

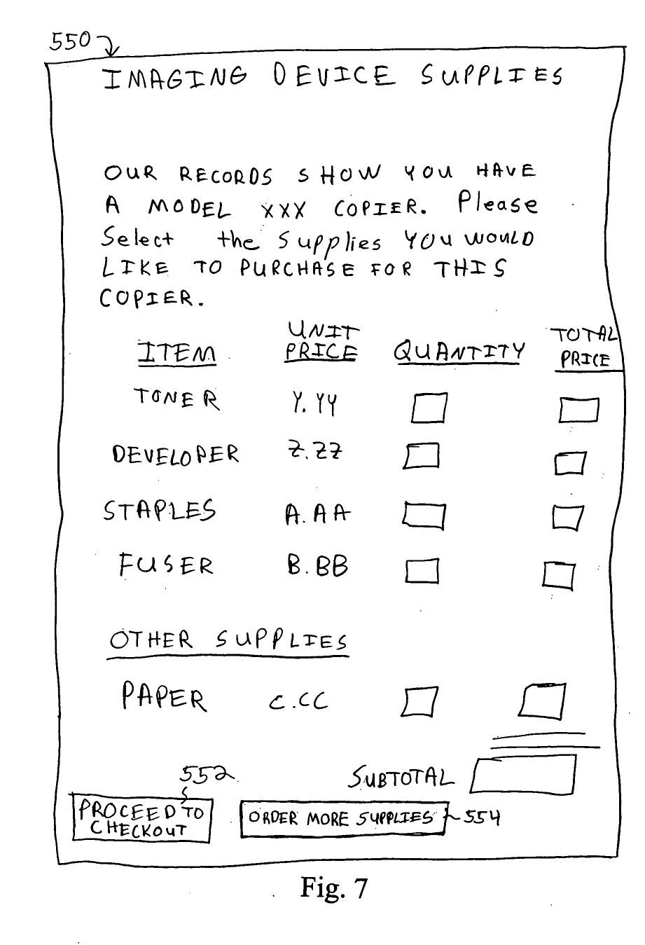

FIGS. 6A-6D illustrate the process of purchasing on-line goods or services such as supplies for the image forming device, and also the process of generating a bill for this on-line purchase. After starting, step 450 is optionally performed which examines whether it is possible to determine the on-line purchaser. The on-line purchaser may be identified at this time by the user entering a user name and/or user password. As an alternative or additional manner of determining the user, conventional cookies or cookie numbers which are utilized with Internet transactions and monitoring of web browsers may be utilized to determine the user. An example of how cookie numbers may be utilized and operate to monitor users is disclosed in U.S. Pat. No. 6,055,573 entitled “Communicating with a Computer Based on an Updated Purchase Behavior Classification of a Particular Consumer,” which is incorporated herein by reference. If it is possible to determine the identify of the user in step 450, step 452 is performed by looking-up the equipment of the user. This may be done by examining, for example, the customer database 226 of FIG. 3. Once the equipment of the user is known, step 454 is performed which displays to the user the supplies for the user's leased or purchased machines. An exemplary display which shows the user the supplies which corresponds to his or her machines is shown in a display 550 illustrated in FIG. 7. In FIG. 7, the display 550 indicates, “Our records show you have a model XXX copier. Please select the supplies you would like to purchase for this copier.” Exemplary supplies for a copier which are shown, along with the price include toner, developer, staples, fuser, and paper. The user can select the quantity of each supply which is desired and the total price is displayed. After selecting the supplies which correspond to the machine at issue, the user can complete the purchase by proceeding to the transaction termination by clicking on the “Proceed to Checkout” button 552. Alternatively, the user may order more supplies, or different supplies by clicking on the Order More Supplies button 554. The display 550 of FIG. 7 is merely an exemplary display, and any implementation of the display recited in step 454 may be utilized.

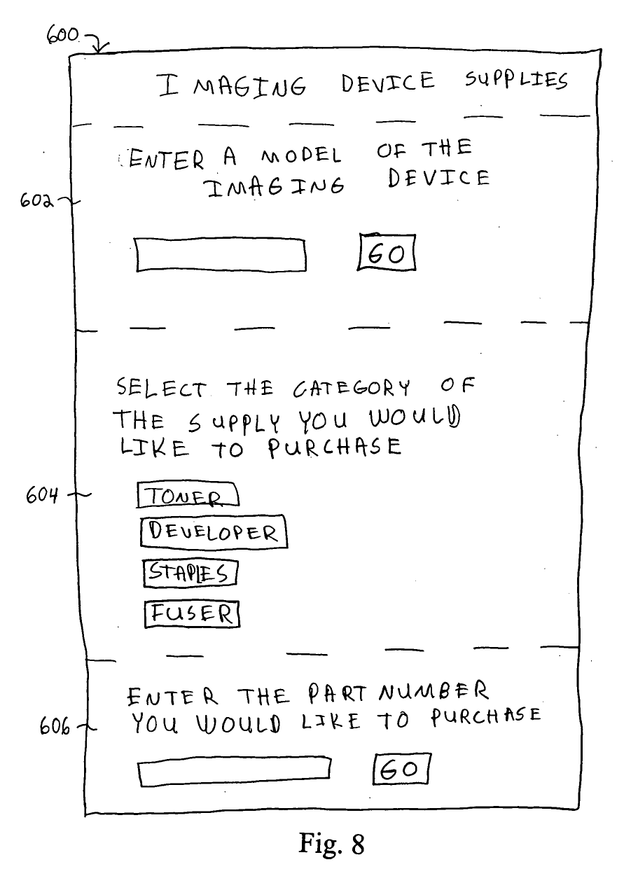

After performing step 454, or when the user is not determined, the user may select the items which are desired to be purchased. The purchase process can use the display 550 described with respect to step 454, or the screen display 600 of FIG. 8. While the purchase is described with respect to supplies for an imaging device or image forming device, the supplies can be any type of goods or services. In FIG. 8, the supplies may be determined by the user entering in section 602 a model of the imaging device at issue, and clicking on the corresponding GO button. The user would then be taken to a list or supplies for the device similar to the list of FIG. 7 which shows the supplies which correspond to the imaging device at issue. The user may also be given the option in section 604 to select the specific type of supply which is desired. For example, the user may be given a choice of toner, developer, staples, or fuser, although any supply or good or service may be displayed including paper. For example, if the user clicks on toner in section 604, the user may be given either a list of machines for which the toner can be selected, or a list of part numbers of the available toner, or the ability to enter the model number of the device for which toner is desired. Alternatively, any type of display or selection may be utilized. Also in the display 600 at the bottom portion 606, the user is allowed to enter the specific part number which is desired to be purchased. This could be the part number of the toner, paper, or any other desired good or service. After entering the part number, the user would click on the corresponding GO button and further information would be indicated regarding the price, availability, options, type, etc., of the part number which is desired.

In step 458, the user has the ability to select more items for purchase. If the user desires to select more items for purchase, for example, by selecting an appropriate button or making some other appropriate indication, flow returns to step 456 which allows further selections of items to be purchased. If step 458 determines that there are no more items to be purchased, flow proceeds to step 460. In step 460, the user may enter a name and password. This name and password can be asked from the user at the time step 460 is performed, or can be asked and/or obtained with respect to step 450, and then it would not be necessary to ask again the same question in step 460 but the entry of such information in step 450 would result in a positive determination in step 460 and flow proceeding to process A in FIG. 6B. If the user enters the name and password in step 460, flow also proceeds to process A. If the user name and password are not received, flow proceeds to process B illustrated in FIG. 6C.

In FIG. 6B, step 470 is performed which determines if the user name and password are registered. If the user name is not registered or the password is not correct or not registered, flow proceeds to process B in FIG. 6C. If the user name and password are registered, flow proceeds to step 472 which calculates the amount due. The total amount due may be the total amount of the items purchased plus any applicable tax plus shipping minus any discounts or coupons.

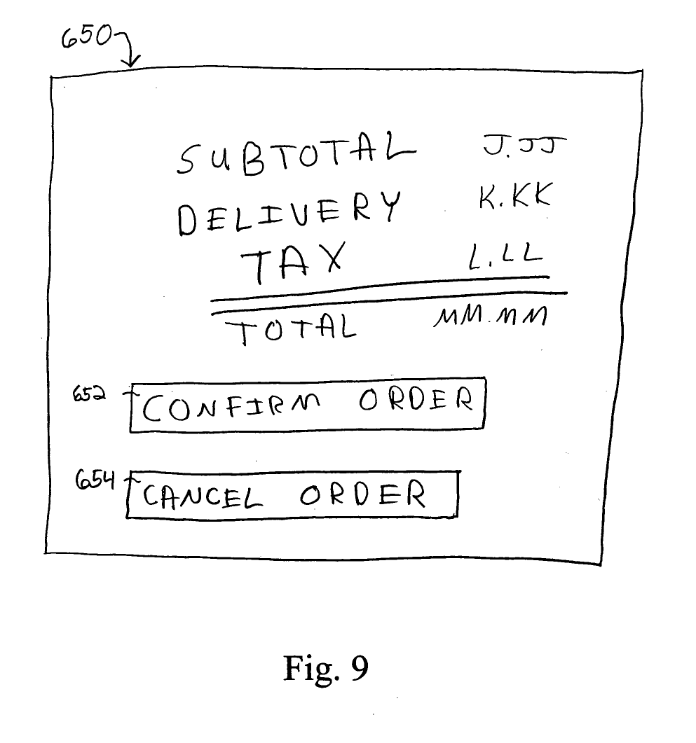

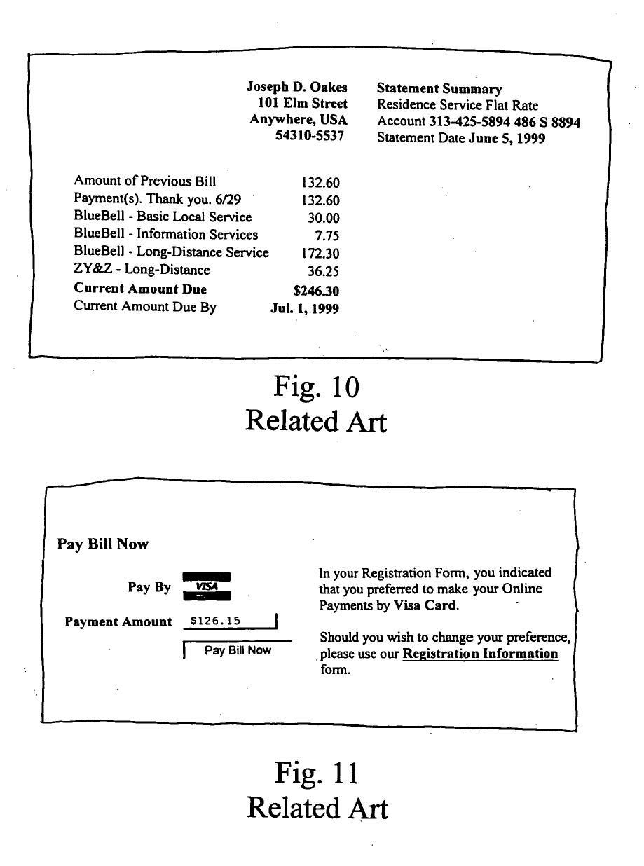

FIG. 9 illustrates a screen display 650 which may be utilized when calculating the total amount due, for example, in step 472 of FIG. 6B (and also step 490 of FIG. 6C). In the screen display 650, the subtotal is displayed along with the delivery charge, tax, and the total due. The delivery charge and tax are optional items and therefore are not required. If the total is acceptable to the user, the user may click or select the Confirm Order button 652. Alternatively, the user may cancel the order by clicking on the Cancel Order button 654. In step 474, the amount due is accumulated or stored and this billing information is saved in a billing database such as database 228 illustrated in FIG. 3. By accumulating, the database may have a separate field indicating the total amount owed by the user for this transaction, and past transactions, if desired. Alternatively, the accumulating may merely be saving the information regarding the present purchase in the database. At this time, if desired, a check may be performed of the amount owed by the user at issue. If the user at issue is passed due on lease payments or purchase payments for the original off-line purchase such as the purchase or lease of an imaging device, and/or the user is behind on payments for previously purchased supplies, a decision may be made not to ship the goods. Alternatively, the goods may be shipped but only under special conditions such as automatic debiting of a bank account, charging of a credit card such as a third party credit card, for example, Visa, Master Card, or American Express, or by waiting for the user or purchaser to transmit funds to cover the purchase of the goods at issue. Once the total due is calculated and the transaction is approved, step 476 issues a shipping order which is an instruction for the goods which are desired to be purchased to be shipped to the user. When or after the shipping order issues or the shipping order is stored in a database such as the shipping database 230, the order is shipped to the customer or user. The shipping method may utilize any type of shipping manner including public and private services. Also, the information may be shipped from any desired location including any type of warehouse or storage facility. Of course, if a service and not a product is at issue, there may not actually be any product shipped but the desired service may be provided in due course.

According to one embodiment of the invention, the bill for the items which are purchased is not immediately sent but may be sent on a particular billing date, or upon the completion of a particular billing cycle. As an example, if a company owns a number of image forming devices (or one device) and purchases supplies for these devices on a regular basis, one bill may be sent each month. Thus, according to an embodiment which is not mandatory to the present invention, step 480 is performed which determines if today, the present day, is a billing date. If it is not, flow returns to step 480 and a bill is not generated until it is determined to be the billing date in step 480. When today is determined to be a billing date in step 480, step 482 is subsequently performed which generates and transmits an electronic bill. The electronic bill of the present invention is a preferred embodiment of the invention and may be transmitted in any desired manner including using electronic mail, transmitting a message that the bill is available at a particular web site and the user subsequently accessing the web site, by facsimile, by a file attached to an electronic mail message, for example in Adobe Acrobat PDF format, or in a spread sheet format, or in any other desired format. Alternatively, a bill which is not an electronic bill may be transmitted such as a paper bill. From step 482 flow proceeds to process C illustrated in FIG. 6D. However, before addressing FIG. 6D, process B will be explained with respect to FIG. 6C.

In process B of FIG. 6C, step 490 is performed which calculates the amount due. This calculation may be performed in the same manner as step 472 of FIG. 6B. Next, step 492 is performed which saves the billing information in the billing database, for example database 228 of FIG. 3. This step may be performed in the same or similar manner as step 474 of FIG. 6B. Next, a shipping order is issued in step 494, and this step may be performed in the same or similar manner as step 476 of FIG. 6B is performed. Likewise, the saving of the shipping order in the shipping database and the ultimate shipping of the good or providing of service of step 496 may be performed in the same manner as step 478 of FIG. 6B.

The process of Figure C is performed when the user name and password are not registered. This will ordinarily mean that information regarding the credit history or previous purchases or leases of the customer are not available. Thus, it may not be desirable to extend large amounts of credit to such a person unless the person provides some assurances that payment will be made, for example, such as providing a third party credit card number or providing a bank account to which the charges can be debited. In this case, when the customer does not have a valid user name and password, it is preferable to issue the bill as soon as possible in step 498, without waiting for a billing cycle or a billing date as is done in step 480 of FIG. 6B. However, if desired, step 498 may comprise the same or similar steps as steps 480 and 482. The bill issued in step 498 may be a paper bill or one of the previously described electronic or e-bills. From step 498, flow proceeds to process C illustrated in FIG. 6D. Further, the bill, in step 498 may be issued and if payment for the bill is not received, a charge to a credit card or debit of a bank account may be performed.

FIG. 6D illustrates the process of receiving payments and/or recording an indication that a payment has not been made. In FIG. 6D, step 510 determines if payment has been received from a customer. If it has, the payment information is entered in step 512, for example, in the billing database 228 or the customer database 226, and the process of FIGS. 6A-6D then ends. If payment is not detected as being received from a user in step 510, flow proceeds to step 514 which determines if a predetermined period of time has elapsed without receiving a payment. In other words, this step determines if a bill is past due. If the answer is no in step 514, flow proceeds back to step 510 to determine if payment has been received. If step 514 determines that the predetermined period of time has elapsed, such as a 30 day period, and no payment has been received, a late notice is sent to the customer in step 516.

After step 516, step 518 is performed which determines if a predetermined number of late notices have been sent in step 518. For example, the user may be sent three late notices. If the predetermined number of late notices has not been sent, flow proceeds back to step 510 which, in conjunction with steps 514 and 516 will send another late notice to the customer. If a predetermined number of late notices has been sent, flow proceeds from step 518 to step 520 which stores the nonpayment in the customer database 226, for example. The nonpayment may also be stored in the billing database 228. The nonpayment may trigger any number of subsequent actions such as turning the account over to a third party collection agency, billing a previously registered credit card or debiting a previously registered bank account, for example. Also, such nonpayment may prevent further sales to the customer at issue. After step 520 the process of FIGS. 6A-6D ends.

In accordance with the invention, the step of determining that the customer is an acceptable risk, based on a previous off-line transaction, purchase, or lease, may be performed prior to a purchase, during a purchase, or after an on-line purchase. The determining that the customer is an acceptable risk may be performed by an initial evaluation and approval of the lease. During the transaction, the current payment status and/or credit history may be evaluated, and/or the information contained on the original off-line lease or purchase agreement. It is also possible to perform, in an equivalent manner, a subsequent determination that the customer is an acceptable credit risk by initially indicating that the order is approved based on any type of preliminary information or determination including any information described herein, but subsequently determining that there is a problem with the customer's credit and canceling the order before it is shipped. Additionally, a single electronic bill may be generated by the present invention for both on-line purchases and a lease payment and/or a purchase payment for the off-line transaction.

According to an embodiment of the invention, the product which is purchased on-line or in a subsequent purchase is different from the product which is obtained or purchased through the off-line transaction or subsequent, purchase, or lease. Further, the product which is obtained on-line or through the later transaction may be for use with, or to resupply, the product which is obtained off-line or by the earlier transaction.

The present invention has been described above with respect to general purpose digital computers. The software coding for such computers can readily be prepared by skilled programmers based on the teachings of the present disclosure, as will be apparent to those skilled in the software art. The invention may also be implemented by the preparation of application specific integrated circuits or by connecting an appropriate network of conventional component circuits, as will be readily apparent to those skilled in the art.

The present invention also includes a computer program product which is a storage medium including instructions which can be used to program a computer to perform a process of the invention. The storage medium can include, but is not limited to, any type of disk including floppy disks, optical disks, CD-ROMs, and magneto-optical disks, ROMs, RAMs, EPROMs, EEPROMs, flash memory, magnetic or optical cards, or any type of media suitable for storing electronic constructions. The invention also includes a memory such as any of the described memories herein which store data structure corresponding to the information described herein. Moreover, the invention also includes signals such as carrier waves which transmit the data structures and also the software coding corresponding to the computer program product of the invention.

Obviously, numerous modifications and variations of the present invention are possible in light of the above teachings. It is therefore to be understood that within the scope of the appended claims, the invention may be practiced otherwise than as specifically described herein.

1. A method of communicating, comprising the steps of:
storing a customer's financial information in a supplier computer system based on an off-line transaction between a customer and a supplier;
beginning an on-line purchase by the customer with the supplier and communicating to a server computer by the customer;
determining that the customer is an acceptable credit risk for the on-line purchase using the customer's financial information in the supplier computer system and which is based on the off-line transaction;
communicating to the customer that the on-line purchase has been approved, after said determining step determines that the customer is an acceptable credit risk.

2. A method according to claim 1, wherein said step of storing comprises:
storing the customer's financial information based on a lease.

3. A method according to claim 1, wherein said step of storing comprises:
storing the customer's financial information based on a lease of an image forming device.

4. A method according to claim 1, wherein said step of storing comprises:
storing the customer's financial information based on a purchase of an image forming device.

5. A method according to claim 4, wherein said step of storing comprises:
storing the customer's financial information based on a purchase of at least one of a copier and a facsimile machine.

6. A method according to claim 1, wherein said determining step comprises:
determining that the customer is an acceptable credit risk based the existence of a lease of a machine by the customer.

7. A method according to claim 1, wherein said determining step comprises:
determining that the customer is an acceptable credit risk based the existence of a lease of a machine by the customer and up-to-date payments on the lease.

8. A method according claim 1, wherein said step of communicating to the customer comprises:
communicating that the on-line purchase which is a purchase of supplies for an image forming device which has been obtained through the off-line transaction has been approved.

9. A method according to claim 1, further comprising the step of:
issuing a bill for the on-line purchase.

10. A method according to claim 9, wherein said step of issuing a bill comprises:
issuing an electronic bill for the on-line purchase.

11. A method according to claim 10, wherein said step of issuing a bill comprises:
transmitting the electronic bill for the on-line purchase by email.

12. A method according to claim 10, wherein step of issuing a bill comprises:
notifying said customer that said electronic bill is stored at an Internet site.

13. A method according to claim 12, wherein said notifying step comprises:
notifying said customer by an electronic mail message that said electronic bill is stored at the Internet site.

14. A method according to claim 10, wherein said step of issuing a bill comprises:
issuing a single electronic bill for both the on-line purchase and a lease corresponding to the off-line transaction.

15. A method according to claim 9, further comprising the step of:
printing a paper bill for the on-line purchase, and sending the paper bill to the customer.

16. A method according to claim 9, further comprising the step of:
debiting a pre-registered bank account by an amount corresponding to the on-line transaction.

17. A method according to claim 16, wherein said debiting step comprises:
debiting a pre-registered bank account by an amount corresponding to the on-line transaction and a payment for the off-line transaction.

18. A method according to claim 1, further comprising the step of:
charging a third party credit card of the customer for the on-line transaction.

19. A method according to claim 1, further comprising the step of:
issuing a paper bill for said transaction if said financial information is not valid.

20. A method according to claim 9, wherein said step of issuing comprises:
issuing the bill for the on-line purchase according to a predetermined billing cycle which is greater than one day.

21. A method according to claim 9, wherein said step of issuing comprises:
issuing a single bill for plural transactions occurring over a time period.

22. A method according to claim 1, further comprising the step of:
purchasing a product through the on-line purchase, the product being different from a product obtained through the off-line transaction.

23. A method according to claim 22, wherein said step of purchasing comprises:
purchasing the product through the on-line purchase which is for use with the product obtained through the off-line transaction.

24. A system for communicating, comprising:
means for storing a customer's financial information in a supplier computer system based on an off-line transaction between a customer and a supplier;
means for beginning an on-line purchase by the customer with the supplier and communicating to a server computer by the customer;
means for determining that the customer is an acceptable credit risk for the on-line purchase using the customer's financial information in the supplier computer system and which is based on the off-line transaction; and
means for communicating to the customer that the on-line purchase has been approved, after means for determining determines that the customer is an acceptable credit risk.

25. A system according to claim 24, wherein said means for storing comprises:
means for storing the customer's financial information based on a lease.

26. A system according to claim 24, wherein said means for storing comprises:
means for storing the customer's financial information based on a lease of an image forming device.

27. A system according to claim 24, wherein said means for storing comprises:
means for storing the customer's financial information based on a purchase of an image forming device.

28. A system according to claim 27, wherein said means for storing comprises:
means for storing the customer's financial information based on a purchase of at least one of a copier and a facsimile machine.

29. A system according to claim 24, wherein said means for determining comprises:
means for determining that the customer is an acceptable credit risk based the existence of a lease of a machine by the customer.

30. A system according to claim 24, wherein said means for determining comprises:
means for determining that the customer is an acceptable credit risk based the existence of a lease of a machine by the customer and up-to-date payments on the lease.

31. A system according claim 24, wherein said means for communicating to the customer comprises:
means for communicating that the on-line purchase which is a purchase of supplies for an image forming device which has been obtained through the off-line transaction has been approved.

32. A system according to claim 24, further comprising:
means for issuing a bill for the on-line purchase.

33. A system according to claim 32, wherein said means for issuing a bill comprises:
means for issuing an electronic bill for the on-line purchase.

34. A system according to claim 33, wherein said means for issuing a bill comprises:
means for transmitting the electronic bill for the on-line purchase by email.

35. A system according to claim 33, wherein means for issuing a bill comprises:
means for notifying said customer that said electronic bill is stored at an Internet site.

36. A system according to claim 35, wherein said means for notifying comprises:
means for notifying said customer by an electronic mail message that said electronic bill is stored at the Internet site.

37. A system according to claim 33, wherein said means for issuing a bill comprises:
means for issuing a single electronic bill for both the on-line purchase and a lease corresponding to the off-line transaction.

38. A system according to claim 32, further comprising:
means for printing a paper bill for the on-line purchase.

39. A system according to claim 32, further comprising:
means for debiting a pre-registered bank account by an amount corresponding to the on-line transaction.

40. A system according to claim 39, wherein said means for debiting comprises:
means for debiting a pre-registered bank account by an amount corresponding to the on-line transaction and a payment for the off-line transaction.

41. A system according to claim 24, further comprising:
means for charging a third party credit card of the customer for the on-line transaction.

42. A system according to claim 24, further comprising:
means for issuing a paper bill for said transaction if said financial information is not valid.

43. A system according to claim 32, wherein said means for issuing comprises:
means for issuing the bill for the on-line purchase according to a predetermined billing cycle which is greater than one day.

44. A system according to claim 32, wherein said means for issuing comprises:
means for issuing a single bill for plural transactions occurring over a time period.

45. A system according to claim 24, further comprising:
means for purchasing a product through the on-line purchase, the product being different from a product obtained through the off-line transaction.

46. A system according to claim 45, wherein said means for purchasing comprises:
means for purchasing the product through the on-line purchase which is for use with the product obtained through the off-line transaction.
